(19) United States
(12) Patent Application Publication
(10) Pub. No.: US 2005/0259600 A1
(43) Pub. Date: Nov. 24, 2005

(54) Translation bridge between ethernet and 1394A local links for consumer electronics devices

(75) Inventor: John William (Jack) Chaney, Gilroy, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/103,913

(22) Filed: Apr. 11, 2005

Related U.S. Application Data
(60) Provisional application No. 60/572,081, filed on May 18, 2004.

(51) Int. Cl. H04L 12/28

(52) U.S. Cl. 370/257

(57) ABSTRACT

A translation bridge is provided between Ethernet and 1394A local links for consumer electronics devices. On each logical local link, a link local IP address is allocated for each other logical link to be bridged. The translation bridge then represents each external logical unit as that singular IP address concatenated with an assigned unique Port number which corresponds to the actual IP address and Port number of the external logical unit on its attached link. Therefore, all of the devices on an external link appear as logical units in one physical device. That physical device then presents the union of all of the external logical units' 2027 file response as the local link 2027 file response for discovery. Then, physical packets are translated to the external devices as if emanating from the link local corresponding device. Further, addresses in hyperlinks are translated in exactly the same way, treating addresses and port numbers as the addresses.

### RELATED APPLICATION

Priority is claimed from U.S. provisional patent application Ser. No. 60/572,081, filed May 18, 2004, incorporated herein by reference.

### FIELD OF THE INVENTION

The present invention relates generally to interconnecting networks, and more particularly, to bridging Ethernet and 1394 Local Links.

### BACKGROUND OF THE INVENTION

To participate in wide-area IP networking, a host needs to be configured with IP addresses for its interfaces, either manually by the user or automatically from a source on the network such as a DHCP server. Unfortunately, such address configuration information may not always be available.

In general, the link-local address assignment for IPv4 generates an address that is not routable to other links. The IP devices on a 1394 link cannot be considered a logical part of an Ethernet link, and vice-versa, because the MAC address space is different and the maximum packet sizes are different. Link-Local IPv4 addresses are not suitable for communication with devices not directly connected to the same physical (or logical) link, and are only used where stable, routable addresses are not available (such as on ad hoc or isolated networks).

This problem remains unsolved for link-local IP addresses because link-local IP addresses are unroutable. Some conventional approaches require avoidance of link local address assignment with the addresses assigned from a routable pool by a DHCP server to all devices, where the address pools for each link are disjoint and all addresses assigned must be within the same subnet.

However, such conventional approaches do not allow link local address assignment to be used. The current Universal Plug and Play (UPnP) networking systems require link local address assignments under certain conditions. Further, such conventional approaches do not allow a set of devices, such as consumer electronic devices, on an IP over 1394 link to be mutually conversant with a set of IP conversant Ethernet devices on a adjacent local Ethernet link using an interconnect between the two local links.

### BRIEF SUMMARY OF THE INVENTION

The present invention addresses the above problems. In one embodiment, the present invention provides a method and system that allows a class of consumer electronic devices on an IP over 1394 local link to be mutually conversant with a class of IP conversant Ethernet devices on a adjacent local Ethernet link using an interconnect between the two local links. The present invention further allows IP/1394 devices to interoperate with UPnP devices.

According to an embodiment of the present invention, on each logical local link, a link local IP address is allocated for each other logical link to be bridged. The translation bridge then represents each external logical unit as that singular IP address concatenated with an assigned unique Port number which corresponds to the actual IP address and Port number of the external logical unit on its attached link.

Therefore, all of the devices on an external link appear as logical units in one physical device. That physical device then presents the union of all of the external logical units' 2027 file response as the local link 2027 file response for discovery. Then, physical packets are translated to the external devices as if emanating from the link local corresponding device. Further, addresses in hyperlinks are translated in exactly the same way, treating addresses and port numbers as the addresses.

Other embodiments, features and advantages of the present invention will be apparent from the following specification taken in conjunction with the following drawings.

### BRIEF DESCRIPTION OF THE DRAWINGS

FIG. 1A shows a functional block diagram of a network implementing address translation according to an embodiment of the present invention;

FIG. 1B shows a functional block diagram of another network implementing address translation according to an embodiment of the present invention;

FIG. 2 shows a functional block diagram of another network implementing address translation according to an embodiment of the present invention;

FIG. 3 shows a more detailed functional block diagram of the network of FIG. 2; and

FIG. 4 shows a functional block diagram of another network implementing address translation according to another embodiment of the present invention.

### DETAILED DESCRIPTION OF THE INVENTION

In embodiment, the present invention provides a method and system for providing a translation bridge between Ethernet and 1394A local links for consumer electronics devices. The following description is in the context of CEA-2027 and CEA-931B compliant, IP controlled Graphical User Interfaces for the class of 1394 connected consumer electronics devices, and a similar set of Ethernet connected consumer electronics and information technology devices.

The primary concept in CEA-2027 is that of logical unit, which is addressed by an IP address and Port number, whether it be attached to Ethernet or 1394. According to an embodiment of the present invention, on each logical local link, a link local IP address is allocated for each other logical link to be bridged. The translation bridge then represents each external logical unit as that singular IP address concatenated with an assigned unique Port number which corresponds to the actual IP address and Port number of the external logical unit on its attached link.

Therefore, all of the devices on an external link appear as logical units in one physical device. That physical device then presents the union of all of the external logical units' 2027 file response as the local link 2027 file response for discovery. Then, physical packets are translated to the external devices as if emanating from the link local corresponding device. Further, addresses in hyperlinks are translated in exactly the same way, treating addresses and port numbers as the addresses.

In the example herein, Link-Local addressing, for IPv4 communication between two hosts on a single link is described. A set of hosts is considered to be on the same link, if: when any host A from that set sends a packet to any other host B in that set, using unicast, multicast, or broadcast, the entire link-layer packet payload arrives unmodified, and a broadcast sent over that link by any host from that set of hosts can be received by every other host in that set.

In this example, a host automatically configures an interface with an IPv4 address within a 169.254/16 prefix that is valid for communication with other devices connected to the same physical (or logical) link.

As noted, to interoperate between 2027 devices on a local IP/Ethernet link and a local IP/1394 link, a conventional bridge or a router cannot be used. A 2027 device is defined by its 2027 file. The 2027 file is the union of its logical block descriptions. According to the present invention, a transitional bridge or representational device (RD) is provided in each network, that represents all logical units on one link as a single physical device on the other link.

As shown by the example functional block diagram in FIG. lA, according to an embodiment of the present invention, a transitional bridge or representational device (RD) comprises: in the Ethernet network, an RDe transitional bridge device, and in the 1394 network, an RDf transitional bridge device. The RD further comprises a network interface between the 1394 and Ethernet network.

In this configuration, on each logical local link, a link local IP address is allocated for each other logical link to be bridged. The translation bridge RD then represents each external logical unit as that singular IP address concatenated with an assigned unique Port number which corresponds to the actual IP address and Port number of the external logical unit on its attached link.

In another example functional block diagram in FIG. lB, according to another embodiment of the present invention, a transitional bridge or representational device (RD) comprises: for the Ethernet network, an RDe transitional bridge device, and multiple Ethernet devices (1, . . . , m), the Ethernet devices including corresponding 2027 files (e₁, . . . , eₘ).

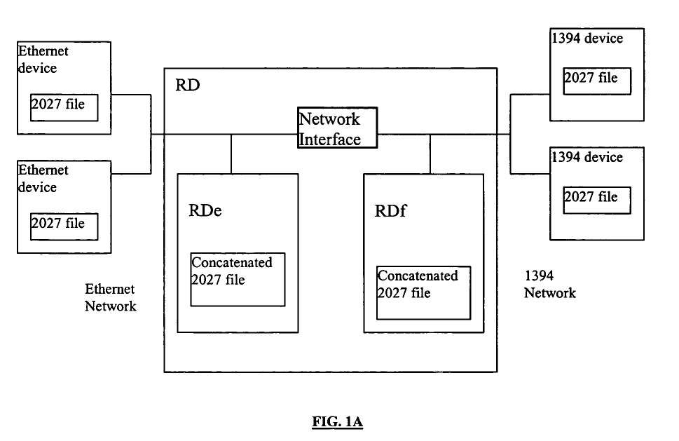

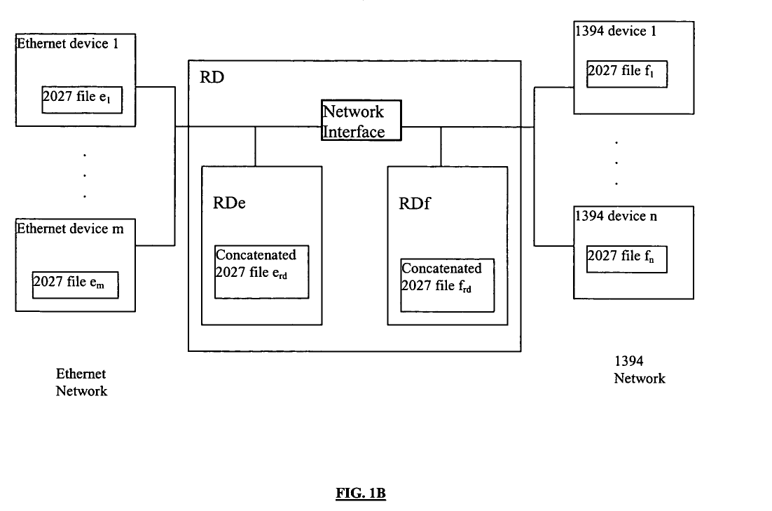

In the example of FIG. 1B, because the RDe represents all the firewire devices to the Ethernet local link, then the concatenated 2027 file corresponding to the RDe is the remapped version of the union of the firewire 2027 files: f₁, . . . , fₙ. Likewise, as the RDf represents the Ethernet devices to the 1394 devices, the 2027 file correspding to the RDf is the remapped version of the union of the Ethernet 2027 files: e₁, . . . , eₘ.

The RD devices further comprises: for the 1394 network, an RDf transitional bridge device, and multiple 1394 devices (1, . . . , n), the 1394 devices including corresponding 2027 files (f₁, . . . , fₙ). The RD further comprises a network interface between the 1394 and Ethernet network.

The RDe device includes a 2027 file f_{rd} which is the union of Ethernet devices' 2027 files e₁, . . . , eₘ. Further, the RDf device includes a 2027 file e_{rd} which is the union of the 1394 devices' 2027 files f₁, . . . , fₙ. The RDf's 2027 file, f_{rd}, is then processed to remap Universal Resource Identifier (URI) values. The RDe's 2027 file, e_{rd}, then processed to remap URI values.

Because the RDf represents the devices which are physically and directly connected on the Ethernet network to the devices which are physically and directly connected on the 1394 network, and the RDe vice versa, then the methods used for the RDf apply precisely to the RDe.

On each logical local link, a link local IP address is allocated for each other logical link to be bridged. The translation bridge RD then represents each external logical unit as that singular IP address concatenated with an assigned unique Port number which corresponds to the actual IP address and Port number of the external logical unit on its attached link.

As such, the RDf is configured such that:
1. The RDf at its Ethernet port receives a link local IP address via link local address assignment (LLAA) on the Ethernet network.
2. The RDf collects the results of 2027 discovery on the Ethernet network and the 2027 files of all other such devices on the Ethernet network, exclusive of those presented by the RDe.
3. The RDf determines a remap table Tf for logical units' (e.g., IP address, port number, Prefix) to present those devices to the 1394 connected devices.
4. The RDf creates its 2027 file f_{rd} as the union of the 2027 files (e₁, . . . , eₘ) from those devices connected directly to the Ethernet network, but with the IP address, port number and Prefix, remapped per the table Tf.
5. Once the 2027 file f_{rd} is formed, the RDf may trigger a reset on the 1394 bus and participate in 2027 discovery on the 1394 network local link.
6. When a 1394 device, e.g. device A, issues an HTTP get of an object from the RDf, then the map Tf is utilized and the RDf makes the corresponding HTTP GET from the corresponding directly connected Ethernet device. This received object and response are used by the RDf to fulfill the original HTTP GET from the device A. Any hyperlinks present in the received object are mapped using the table Tf before sending the result to the device A.

This process is particularly valuable for IPv4 link local addressed devices. IPv6 solves some of these problems in that all IPv6 addresses are routable.

Further, the RDe is configured such that:
1. The RDe at its 1394 port receives a link local IP address via link local address assignment (LLAA) on the 1293 network.
2. The RD3 collects the results of 2027 discovery on the 1394 network and the 2027 files of all other such devices on the 1394 network, exclusive of those presented by the RDf.
3. The RDe determines a remap table Te for logical units' (e.g., IP address, port number, Prefix) to present those devices to the Ethernet connected devices.
4. The RDe creates its 2027 file e_{rd} as the union of the 2027 files (f₁, . . . , fₙ) from those devices connected directly to the 1394 network, but with the IP address, port number and Prefix, remapped per the table Te.
5. Once the 2027 file e_{rd} is formed, the RDe may trigger a reset on the Ethernet network and participate in 2027 discovery on the Ethernet network local link.
6. When an Ethernet device, e.g. device B, issues an HTTP get of an object from the RDe, then the Te map is utilized and the RDe makes the corresponding HTTP GET from the corresponding directly connected 1394 device. This received object and response are used by the RDe to fulfill the original HTTP GET from the device B. Any hyperlinks present in the received object are mapped using the table in Te before sending the result to the device B.

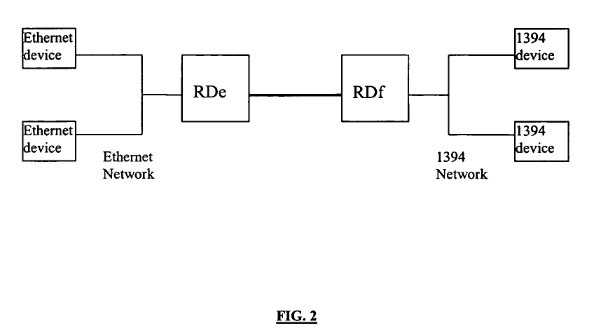

FIG. 2 shows a functional block diagram, according to another embodiment of the present invention, wherein in the Ethernet network an RDe transitional bridge device is provided, and in the 1394 network an RDf transitional bridge device is provided. In this configuration, on each logical local link, a link local IP address is allocated for each other logical link to be bridged. The translation bridge then represents each external logical unit as that singular IP address concatenated with an assigned unique Port number which corresponds to the actual IP address and Port number of the external logical unit on its attached link.

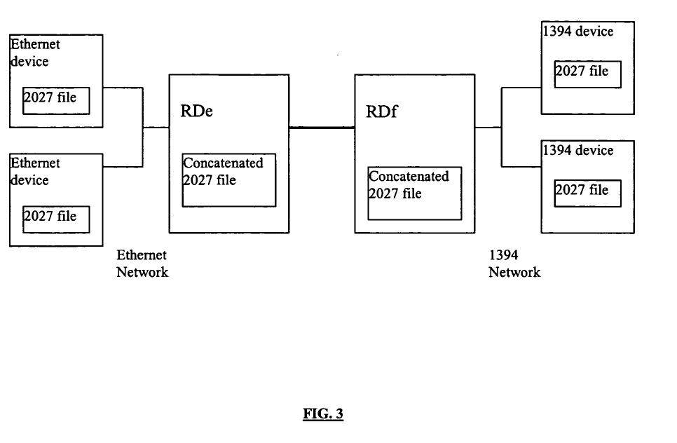

Referring to the more detailed block diagram in FIG. 3, the Ethernet side RDe device includes a 2027 file that represents the entire logical local link of 2027 devices in the 1394 network. The 2027 file for the Ethernet side RDe device comprises a concatenation of all of the separate 2027 files for the 1394 (firewire) devices.

The RDe device in the Ethernet network represents all of the 1394 devices to the 2027 compliant devices in the Ethernet network. All of the devices on an external link appear as logical units in one physical RDe device. That RDe physical device then presents the union of all of the external logical units' 2027 file response as the local link 2027 file response for discovery.

Then, physical packets are translated to the external devices as if emanating from the link local corresponding device. This process refers to either translation or direction (the process is reflexive). As such, the corresponding device can be the other type of device from what is being represented (e.g., the corresponding device can be either a 1394 or an Ethernet device).

Further, addresses in hyperlinks are translated in exactly the same way, treating addresses and port numbers as the addresses. Port numbers are remapped to make unique assignment for the RDe device wherein the RDe device is a legitimate 2027 compliant Ethernet device in the Ethernet network.

The 1394 side RDf device includes a 2027 file that represents the entire logical local link of 2027 devices in the Ethernet network. The 2027 file for the RDf device is the concatenation of the 2027 files from all of the Ethernet devices, except the RDe device.

The RDf firewire 2027 compliant device in the 1394 network represents all of the 2027 Ethernet devices to the 2027 compliant devices in the 1394 network. All of the devices on an external link appear as logical units in one physical RDf device. That RDf physical device then presents the union of all of the external logical units' 2027 file response as the local link 2027 file response for discovery.

Then, physical packets are translated to the external devices as if emanating from the link local corresponding device. Further, addresses in hyperlinks are translated in exactly the same way, treating addresses and port numbers as the addresses. Again, port numbers are remapped to make a unique assignment for the RDf device.

Accordingly, HTTP GET commands from a 1394 device on the 1394 network to the RDf device are reflected to the proper Ethernet logical unit in the Ethernet network using a port number remap. The returned content from that proper Ethernet logical unit comprises XHTML content, wherein the hyperlinks contained in the content are also port number remapped. Hyperlinks that are native to an Ethernet device are port mapped within the RDf so that RDf has a unique representation of it on 1394 at the RD_{f} interface. Likewise, the hyperlinks that are physically resident on the 1394 local link are port mapped within the RDₑ to have a unique representation on the Ethernet local link.

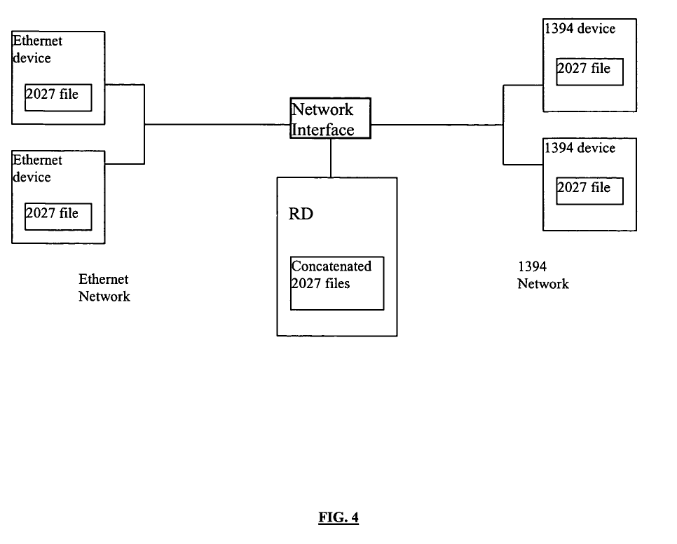

As such, when the hyperlinks are activated in a 1394 result from a GET generated to the RDf device, the activations are reflected to the proper Ethernet logical units in the Ethernet network. In another embodiment of the present invention shown in FIG. 4, one RD device is utilized, which is a combination of the functionality of the RDe and RDf devices described above.

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspects of the invention to the embodiments illustrated. For example, other types of networks in place of Ethernet and 1394 networks maybe utilized.

The aforementioned example architectures above according to the present invention, can be implemented in many ways, such as program instructions for execution by a processor, as logic circuits, as ASIC, as firmware, etc., as is known to those skilled in the art. Therefore, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

1. A method of providing address translation between a first network and an external network, the first network including logical devices on a local link and the external network including logical devices on another local link, the method comprising the steps of:
in a translation device:
allocating a link local address for each of the external logical devices in the external network,
representing to the devices in the first network, each of the external logical devices at the corresponding allocated link local addresses, wherein the translation device presents to the devices in the first network a union of the external logical devices.

2. The method of claim 1 wherein the steps of allocating a local link address for each external logical device further comprises the steps of including in each local link address a unique port number corresponding to the actual address and port number of the corresponding external logical device in the external network.

3. The method of claim 1 further including the steps of translating physical packets to the external devices as though emanating from the link local corresponding device.

4. The method of claim 2 further including the steps of translating physical packets to the external devices as though emanating from the link local corresponding device, treating addresses and port numbers as the addresses.

5. The method of claim 1 further including the steps of translating addresses in content, to the external devices as though emanating from the link local corresponding device.

6. The method of claim 2 further including the steps of translating addresses in content, to the external devices as though emanating from the link local corresponding device, treating addresses and port numbers as the addresses.

7. The method of claim 1 wherein the devices in the first network are 2027 type devices, and the devices in the external network are 2027 devices.

8. The method of claim 1 wherein the first network comprises a 1394 network and the external network comprises an Ethernet network.

9. The method of claim 7 wherein each of the external devices includes a 2027 file including local address information, and further including the steps of combining the 2027 device information files of the external devices into a 2027 file in the translation device to provide address translation.

10. The method of claim 1 further including the steps of:
in a translation device:
allocating a link local address for each of the logical devices in the first network,
representing to the devices in the second network, each of the logical devices in the first network at the corresponding allocated link local addresses, wherein the translation device presents to the devices in the external network a union of the logical devices in the first network.

11. The method of claim 10 wherein the steps of allocating a local link address for each logical device in the first network further comprises the steps of including in each local link address a unique port number corresponding to the actual address and port number of the corresponding logical device in the first network.

12. The method of claim 10 further including the steps of translating physical packets to the devices in the first network as though emanating from the link local corresponding device.

13. The method of claim 11 further including the steps of translating physical packets to the devices in the first network as though emanating from the link local corresponding device, treating addresses and port numbers as the addresses.

14. The method of claim 10 further including the steps of translating addresses in content, to the devices in the first network as though emanating from the link local corresponding device.

15. The method of claim 11 further including the steps of translating addresses in content, to the devices in the first network as though emanating from the link local corresponding device, treating addresses and port numbers as the addresses.

16. A controller that provides address translation between a first network and an external network, the first network including logical devices on a local link and the external network including logical devices on another local link, the controller comprising:
a translation device that allocates a link local address for each of the external logical devices in the external network, and represents to the devices in the first network, each of the external logical devices at the corresponding allocated link local addresses, wherein the translation device presents to the devices in the first network a union of the external logical devices.

17. The controller of claim 16 wherein an allocating local link address for each external logical device further includes a unique port number corresponding to the actual address and port number of the corresponding external logical device in the external network.

18. The controller of claim 16 wherein the controller further translates physical packets to the external devices as though emanating from the link local corresponding device.

19. The controller of claim 17 wherein the controller further translates physical packets to the external devices as though emanating from the link local corresponding device, treating addresses and port numbers as the addresses.

20. The controller of claim 16 wherein the controller further translates addresses in content, to the external devices as though emanating from the link local corresponding device.

21. The controller of claim 17 wherein the controller further translates addresses in content, to the external devices as though emanating from the link local corresponding device, treating addresses and port numbers as the addresses.

22. The controller of claim 16 wherein the devices in the first network are 2027 type devices, and the devices in the external network are 2027 devices.

23. The controller of claim 17 wherein the first network comprises a 1394 network and the external network comprises an Ethernet network.

24. The controller of claim 22 wherein each of the external devices includes a 2027 file including local address information, and further including the steps of combining the 2027 device information files of the external devices into a 2027 file in the translation device to provide address translation.
